(19) United States
(12) Patent Application Publication
(10) Pub. No.: US 2010/0164806 A1
(43) Pub. Date: Jul. 1, 2010

(54) TARGET AND CLUTTER ADAPTIVE ON-OFF TYPE TRANSMIT PULSING SCHEMES

(76) Inventor: UNNIKRISHNA SREEDHARAN PILLAI, Harrington Park, NJ (US)

Correspondence Address: Mr. Walter J. Tencza Jr., Suite 210, 100 Menlo Park, Edison, NJ, 08837, US

(21) Appl. No.: 12/344,878

(22) Filed: Dec. 29, 2008

(51) Int. Cl. G01S 1/00

(52) U.S. Cl. 342/385

(57) ABSTRACT

One or more embodiments of the present invention relates to the design an adaptive transmit non-periodic ON-OFF pulse width modulated (PWM) signal sequence over a radar dwell time that is matched to the target and clutter characteristics so as to maximize the target response adaptively. In this context, in the first step, some optimality criterion such as maximizing the ratio of the target output signal power to the mean clutter power at the receiver input is used to design a pre-transmit waveform. In the second step, a Pulse Width Modulation method is used to convert the pre-transmit waveform so designed to a non-periodic ON-OFF pulse width modulated (PWM) waveform signal without destroying the target and clutter matching characteristics of the pre-transmit signal. This allows maximum response from the target and minimum response from the clutter and the environment when the target and its surroundings are interrogated with the non-periodic ON-OFF pulse width modulated (PWM) signal waveform.

### STATEMENT REGARDING FEDERALLY SPONSORED RESEARCH OR DEVELOPMENT

The disclosed technology is based upon work supported and/or sponsored by the Air Force Research Laboratory (AFRL), Rome, N.Y., under contract No. FA8750-06-C-0202 titled “Waveforms for Simultaneous Air and Ground Surveillance operations” dated 29 Jun. 2006 and amended 9 Sep. 2008.

### FIELD

The disclosed technology relates to radar, sonar and wireless signal processing.

### BACKGROUND

In the prior art there are various techniques for creating transmit signals or waveforms and sending those transmit signals or waveforms out towards a target, such as an airplane, in order to detect the target. Typically the transmit signals interact with the target and response signals are received back. A response signal may include both a target output response signal which is due to the target, and a clutter response signal, which is due to clutter. The clutter, may be, for example, a mountain, terrain such as ground and forests and other interfering objects such as other airplanes. It is desirable to maximize the target output response signal or signals and minimize the clutter response signal or signals.

FIG. 2 shows a prior art technique for creating a transmit signal ƒ(t) and sending it out towards a target. In FIG. 2, the transmit signal ƒ(t) is a chain of rectangular periodic pulses. The transmit signal ƒ(t) is used to interrogate or detect a target 102. The transmit signal ƒ(t) is transmitted by a transmitter 112a towards the target 102 and towards clutter 104. The target 102 may have an impulse response q(t). The target impulse response q(t) is the response signal received back at an input port of a receiver 112b, due to an impulse transmit signal sent out from the transmitter 112a. The target impulse response q(t) is the response received from the target 102 due to interaction with an impulse transmit signal. The impulse response q(t) for the target 102, can be characterized as the signature of the target 102 in terms of its response to an impulse function in the time domain. The impulse response q(t) of the target 102 dictates how the target 102 interacts with an otherwise arbitrary transmit signal ƒ(t), and the target output response y(t) to an arbitrary transmit signal ƒ(t) is determined by the convolution of the target impulse response q(t) and the arbitrary transmit signal ƒ(t) as known in the prior art.

In FIG. 2, the waveform y(t) represents a target return or output response signal and c(t) a clutter response signal due to the transmit signal ƒ(t).

In a conventional prior art pulsing method, a periodic rectangular pulse stream, such as the rectangular pulse stream 101 shown in FIG. 2, is modulated with a chirp signal to generate an actual transmit waveform that interrogates a target. However, the chirp modulated periodic pulse stream is a generic waveform that is used to interrogate all types of targets, and it is not designed to take advantage of the specific characteristics of a target, such as 102 or of clutter, such as 104.

As is well known in the prior art, a “matched filter”, which is a receiver filter response that is matched to an incoming waveform by time-reversing the incoming waveform and shifting it to the right by a specific time delay, maximizes a receiver filter output response at a specific time-instant in a white noise case. (See A. Papoulis and S. U. Pillai, “Probability, Random Variables”, McGraw-Hill Companies, New York, 2001).

FIG. 3 shows a prior art technique in which the waveform q(t) represents the impulse response of a target and hence its matched filter waveform q(tₒ−t) corresponding to a specific time shift tₒ when used as a transmit signal will generate a maximum target response at time instant tₒ for output signal 203 from a target 202 with impulse response 202a.

In U.S. Pat. No. 5,486,833 to Barrett, issued on Jun. 23, 1996, a means is disclosed for generating and transmitting a time frequency wave packet (pulse) which is the complex conjugate of the impulse response of a combined medium and target. In that patent, the wave packet signals are matched to both the medium and the target for maximum propagation through the medium and maximum reflectance from the target. (Barrett, col. 2, Ins. 27-43).

The matched transmit signal technique can be contrasted with the prior art situation in FIG. 4A where the same periodic rectangular pulse stream is transmitted towards all targets without any adaptivity. Observe that the repeated matched illumination transmit strategy of the prior art in FIG. 4B extends the matched transmit waveform situation of the prior art of FIG. 3 and this procedure generates more energy at a receiver input compared to any other waveform when there are no other interfering signals.

Generally, matched filter illumination maximizes target output energy and hence results in improved detection probability, which is generally known in the prior art as shown in U.S. Pat. No. 5,486,833, which is incorporated by reference herein. However for the purposes of transmission, the direct use of a transmit waveform generated by a target matched response as in U.S. Pat. No. 5,486,833, or generated using any other optimality criterion such as described in U.S. patent application Ser. No. 11/623,965, filed Jan. 17, 2007, Ser. No. 11/681,218, filed Mar. 2, 2007, and Ser. No. 11/747,365, filed May 11, 2007, which are incorporated by reference herein, is impractical due to the fact that the target matched response transmit waveform lacks the property of a constant modulus and in particular does not having ON-OFF characteristics. In contrast, a rectangular waveform of the prior art has a constant modulus and ON-OFF characteristics, but does not give good results. In this context, the problem addressed in this application is how to adapt waveforms so as to make them compatible with currently used prior art rectangular pulsing techniques.

### SUMMARY

In one or more embodiments of the present invention a computer processor superimposes, overlaps, or intersects a first signal or pre-transmit signal and a secondary signal to form a non-periodic ON-OFF pulse width modulated (PWM) transmit signal. The PWM transmit signal is then transmitted by a transmitter to interrogate a target. The first signal or pre-transmit signal may be a type of signal which was used as a transmit signal in the prior art, such as a target matched response transmit waveform signal.

One or more embodiments of the present invention generate a non-periodic rectangular pulse-stream that is adaptive to an environment and which may be implemented through a three-step procedure. In the first step, a suitably optimum transmit signal waveform is generated, determined, constructed, and/or formed using a criterion such as a matched filter criterion that maximizes a target output response at a specific time instant, or by another criterion such as by jointly maximizing a target response and minimizing clutter responses and noise effects.

The optimum transmit signal waveform so generated can have any shape but typically will not have the ON-OFF shape of a traditional rectangular pulse waveform. In the second step, the optimum transmit signal waveform with arbitrary signal shape in the time domain is converted to a non-periodic rectangular pulse of an ON-OFF type signal waveform using a pulse width modulation method. A pulse width modulation method allows a non-periodic pulse waveform so generated to possess significant features of the optimum transmit signal waveform generated in the first step. In the third step, this new non-periodic rectangular pulse signal waveform is chirp modulated and transmitted towards the target of interest. The non-periodic signal waveform so transmitted possesses the optimum properties of the original optimum transmit signal waveform developed in the first step while retaining the ON-OFF characteristics of a pulse signal.

In one embodiment of the present invention, a computer processor forms a transmit signal for transmitting out to a target. In at least one embodiment, the transmit signal is comprised of a pulse width modulated (PWM) signal, which is formed from the superposition or intersection of an original optimum transmit signal and a secondary signal. The original signal may be a matched transmit signal which corresponds to the impulse response of a target to an impulse signal, or a signal generated by another criterion such as jointly maximizing the target response and minimizing the clutter responses and noise effects. The secondary signal may be a ramp signal.

One of the objects of at least one embodiment of the present invention is to design an adaptive transmit rectangular pulse sequence over a radar dwell time that is matched to target and clutter characteristics so as to maximize a target response adaptively. The transmit signal may be a series of rectangular pulses whose width is determined by using a pulse width modulation method.

In one or more embodiments of the present invention, a Pulse Width Modulation (PWM) method is used to provide a target adaptive transmit waveform that is a non-periodic sequence of rectangular pulses. Pulse Width Modulation techniques, generally, are well known since the second World War, and are used in digital communication theory for data transmission quite extensively. (See Z. Song, D. V. Sarwate, “The Frequency Spectrum of Pulse Width Modulated Signals”, Elsevier, Signal Processing, Vol. 83, pp. 2227-2258, 2003 and also D. C. Youla, “An Exact Pseudo-Static Time-Domain Theory of Natural Pulse Width Modulation”, Submitted to Signal Processing, January 2008, Revised May 2008].

In one or more embodiments of the present invention transmit waveforms are made target adaptive by selecting, in a first step, a matched transmit waveform that is time reversed and suitably time shifted version of an impulse response of a target to an impulse signal. In one or more embodiments of the present invention these target adaptive transmit waveforms do not possess the rectangular pulse shape or constant modulus property. However, using pulse width modulation (PWM), the matched transmit waveforms can be modified into a non-periodic rectangular pulse sequence and if the target has low pass filter characteristics, the transmit PWM signal waveform when it interacts with the target regenerates the matched transmit signal waveform resulting in a maximum output signal from the target.

### BRIEF DESCRIPTION OF THE DRAWINGS

FIG. 1 shows a diagram of an apparatus for use in accordance with an embodiment of the present invention, along with a target and clutter;

FIG. 2 shows a simplified diagram of a prior art technique of a transmitter sending out a rectangular periodic pulse transmit signal which interacts with a target and clutter, and target and clutter output responses to the transmit signal, which are received by a receiver;

FIG. 3 shows a simplified diagram of a prior art technique, such as similar to what is disclosed in U.S. Pat. No. 5,486,833, incorporated herein by reference, of a transmitter sending out a target matched, or target and medium matched as in U.S. Pat. No. 5,486,833 waveform transmit signal (that is a complex conjugate, and time shifted version of the target impulse response) which interacts with a target, a target impulse response function, and a target output response to the target matched waveform transmit signal;

FIG. 4A shows a simplified diagram of a prior art technique of a transmitter sending out a rectangular periodic pulse transmit signal which interacts with a target, a target impulse response function, and a target output response to the pulse transmit signal;

FIG. 4B shows a simplified diagram of a prior art technique (such as similar to what is disclosed in U.S. Pat. No. 5,486,833, incorporated herein by reference) of a transmitter sending out a target matched waveform sequence transmit signal which interacts with a target, a target impulse response function, and a target output response to the target matched waveform sequence transmit signal;

FIG. 5A shows a graph ƒ(t) of a first signal or pre-transmit signal designed using some optimality criterion such as that of an impulse response of a target, time reversed and delayed by time instant tₒ.

FIG. 5B shows two graphs which explain a method in accordance with an embodiment of the present invention, wherein one graph is of a ramp signal superimposed over the signal of FIG. 5A, with intersections of the two signals identified, the signals graphed versus time; and wherein the second graph is of a pulse width modulated signal, which is based on the intersections of the first graph;

FIG. 6 shows a graph showing details of part of the ramp signal and the target matched transmit signal of FIG. 5B, and the pulse width modulated signal of FIG. 5B;

FIG. 7 shows a diagram of a prior art technique of inputting a nonlinear modulation signal, such as x(t), into a linear filter (which represents a target), and in response an output signal y(t) supplied at an output of the linear filter;

FIG. 8 shows a transfer function for a low pass filter for undistorted reconstruction of a low pass transmit signal from a pulse width modulated signal in accordance with an embodiment of the present invention, wherein the target may have the characteristics of the low pass filter of FIG. 8;

FIG. 9 shows a diagram of a pulse width modulated transmit signal p(t) split into a first input signal ƒ(t) representing a desired component and a second input signal

$${\sum }_{k} {x}_{k} ( t )$$

representing undesired nonlinear distortion components input into the same filter, the totality of which shows the effects of inputting the pulse width modulated signal p(t) through a linear filter, wherein the linear filter is used to represent a target, such as the target in FIG. 1;

FIG. 10A shows a filter such as with characteristics as in FIG. 8 which is used to create a distortion free reconstruction of a signal ƒ(t) from a pulse width modulated signal p(t) in accordance with an embodiment of the present invention, and the target may have the characteristics of the filter of FIG. 10A so that when the input signal p(t) is transmitted towards the target, the underlying signal ƒ(t) is convolved with the target impulse response to create the target output response;

FIG. 10B shows transmission of a pulse width modulated signal towards the target and receiving a target output response in accordance with an embodiment of the present invention;

FIG. 11A shows a typical target impulse response signal q(t);

FIG. 11B shows a target matched transmit signal q(tₒ−t), associated with the target impulse response in FIG. 11A;

FIG. 11C shows a rectangular transmit waveform signal of a prior art technique;

FIG. 11D shows a pulse width modulation (PWM) transmit signal for the target matched pre-transmit signal in FIG. 11B;

FIG. 12A shows three different target output response signals (also called receiver input signals) obtained for three different transmit signals; the first target output response signal (also called receiver input signal) is obtained for a target matched transmit waveform signal (dashed line) shown in FIG. 11B; the second target output response signal (also called receiver input signal) is obtained for a target matched and pulse width modulated transmit waveform signal (dotted line) shown in FIG. 11D; the third target output response signal (also called receiver input signal) is obtained for a rectangular transmit waveform signal of the prior art (solid line) shown in FIG. 11C;

FIG. 12B shows three different receiver output signals due to three different transmit signals; the first receiver output signal due to the target matched transmit waveform signal (dashed line) in FIG. 12A, the second receiver output signal due to target matched and pulse width modulated transmit waveform (dotted line) in FIG. 12A, and the third receiver output signal due to a rectangular transmit waveform used in the prior art (solid line) in FIG. 12A;

FIG. 13A shows another typical target impulse response signal q(t);

FIG. 13B shows a matched filter target transmit signal q(tₒ−t), associated with the target impulse response signal in FIG. 13A;

FIG. 13C shows a rectangular transmit waveform signal of a prior art technique;

FIG. 13D shows the pulse width modulation (PWM) transmit signal associated with the target matched transmit signal in FIG. 13B;

FIG. 14A shows three different target output response signals (which are also called receiver input signals which are supplied to a receiver such as the receiver/transmitter of FIG. 1) due to three different transmit signals; the first target output response signal is obtained for a target matched transmit waveform signal (dashed line) shown in FIG. 13B; the second target output response signal is due to a target matched and pulse width modulated transmit waveform (dotted line) shown in FIG. 13D, and the third target output response signal is due to a rectangular transmit waveform signal of the prior art (solid line) shown in FIG. 13C;

FIG. 14B shows three different receiver output signals due to three different transmit signals; the first receiver output signal due to the target matched transmit waveform signal (dashed line) in FIG. 14A; the second receiver output signal due to target matched and pulse width modulated transmit waveform signal (dotted line) in FIG. 14A, and the third receiver output signal due to a rectangular transmit waveform signal (solid line) in FIG. 14A;

FIG. 15 shows a flow chart of a method for using the apparatus of FIG. 1 in accordance with an embodiment of the present invention.

### DETAILED DESCRIPTION OF THE DRAWINGS

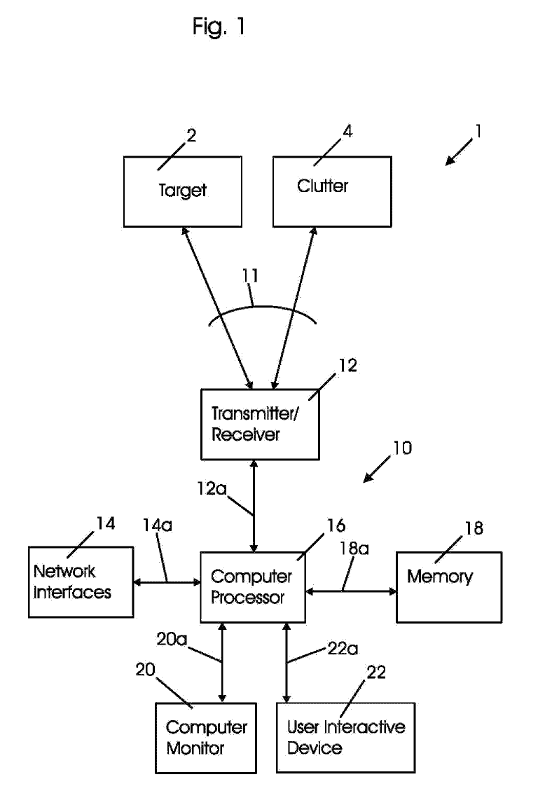

FIG. 1 shows a diagram 1 of an apparatus 10 for use in accordance with an embodiment of the present invention, a target 2, and clutter 4. The target may be, for example, an airplane, and the clutter, may be, for example, a mountain, terrain such as ground and forests, and other interfering objects such as other airplanes or jammers.

The apparatus 10 may include a transmitter/receiver 12 for transmitting wireless signals, such as radio frequency signals over the airwaves or wireless channel 11. The transmitter/receiver 12 may communicate with a computer processor 16 via communications link 12a. The apparatus 10 may also include network interfaces 14, a memory 18, a computer monitor 20, and a user interactive device 22, which may communicate with the computer processor 16 via communications links 14a, 18a, 20a, and 22a, respectively. The communication links 12a-22a may be any type of communications links such as hardwired, wireless, or optical. The memory 18 may be any type of computer memory.

The computer processor may cause the transmitter/receiver 12 to transmit signals. The memory 18 may store characteristics of or data relating to signals to be transmitted by the transmitter/receiver 12. The user interactive device 22 may include a computer keyboard, computer mouse, or computer touchscreen, any of which can be used to enter characteristics of signals for transmitting from transmitter/receiver 12. Signals, characteristics of signals, or data relating to signals can be displayed on the computer monitor 20 or output or input via network interfaces, such as via the internet, by action of the computer processor 16.

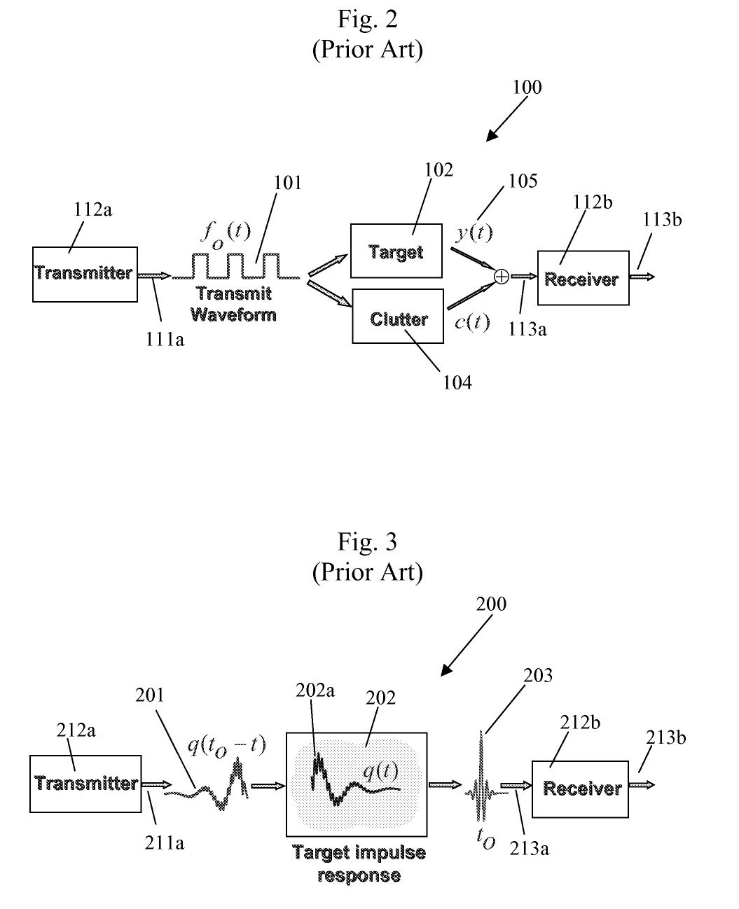

FIG. 2 shows a prior art diagram 100 which includes a representation of a transmit signal 101 which can be transmitted from a transmitter 112a. The transmit signal 101 may be formed by a computer processor. The transmit signal 101 may be a series of pulses or a rectangular transmit waveform signal and may be referred to as the transmit signal waveform 101 or ƒₒ(t). The transmitter 112a may include an output port 111a for transmitting signals.

After the transmit signal 101 is transmitted out by transmitter 112a the transmit signal interacts with both a target 102 and clutter 104. A returning signal received back at an input port of a receiver 112b due to the target 102 is referred to as y(t) or the target output response marked 105, and is shown in FIG. 2. A returning signal received back at the input port of the receiver 112b due to the clutter 104 is referred to as c(t). In practice, the returning signal due to the target y(t) and the returning signal due to clutter c(t) are combined together along with any noise when they are received back at the input port of the receiver 112b. The receiver 112b has an input port 113a in FIG. 2 and an output port 113b, at which receiver output signals are supplied.

Transmit waveforms for detecting targets, such as target 102 in FIG. 2, should be designed to maximize the target response output y(t) or 105 and/or to minimize the clutter response c(t) so as to better discriminate the target 102 from the clutter 104.

FIG. 3 shows a diagram 200 regarding a prior art technique. The diagram 200 shows transmitter 212a and a target 202. The transmitter 212a has an output port 211a. In the diagram 200, a computer processor has been programmed to cause the transmitter 212a to transmit what can be called a “target matched transmit waveform signal” q(tₒ−t), marked as 201, that may be formed by a computer processor by time-reversing an impulse response waveform signal q(t) for the target 202, to generate q(−t) and then time-shifting it by tₒ to generate q(tₒ−t). The impulse response waveform signal q(t) can be determined, for example, in the prior art, by a computer processor by first sending out an impulse transmit signal from the transmitter/receiver 212, and receiving a return signal at an input portion 213a of the receiver 212b or by analyzing prior information stored about each target in a computer memory. The target impulse response q(t) characterizes a signature of the target 202 in terms of the target 202's output response to an impulse function in the time domain, and the target impulse response q(t) dictates how the target 202 interacts with an otherwise arbitrary transmit signal ƒ(t). The target output response y(t) to an arbitrary transmit signal ƒ(t) is determined by the convolution of the target impulse response q(t) and the arbitrary transmit signal ƒ(t) as known in the prior art. The target impulse response waveform q(t) and/or data or characteristics relating thereto can be stored in a computer memory, such as computer memory 18, displayed on a computer monitor, such as computer monitor 20, or sent out or received via network interfaces 14.

In addition, the diagram 200 in FIG. 3 shows a target output response waveform 203. The target matched transmit waveform signal 201 when it interacts with the target 202 through its impulse response 202a generates a target output response 203. Thus the target output waveform 203 in FIG. 3 is the convolution of the target matched waveform signal q(tₒ−t), marked 201, and the target impulse response q(t), marked 202a, and the target output response 203 peaks at time instant tₒ because of the target matched property of the target matched transmit waveform signal 201. Preferably, in one embodiment of the present invention, the transmit signal 201 has been selected so that the peak of the target output response 203 is greater than or equal to the peak that would be obtained for any transmit signal other than 201, with the same energy as transmit signal 201. I.e., if we used any other transmit signal, having the same energy as 201, but of a different form than 201, we would obtain a target output response with a peak that is less than or equal to the peak of the target output response 203.

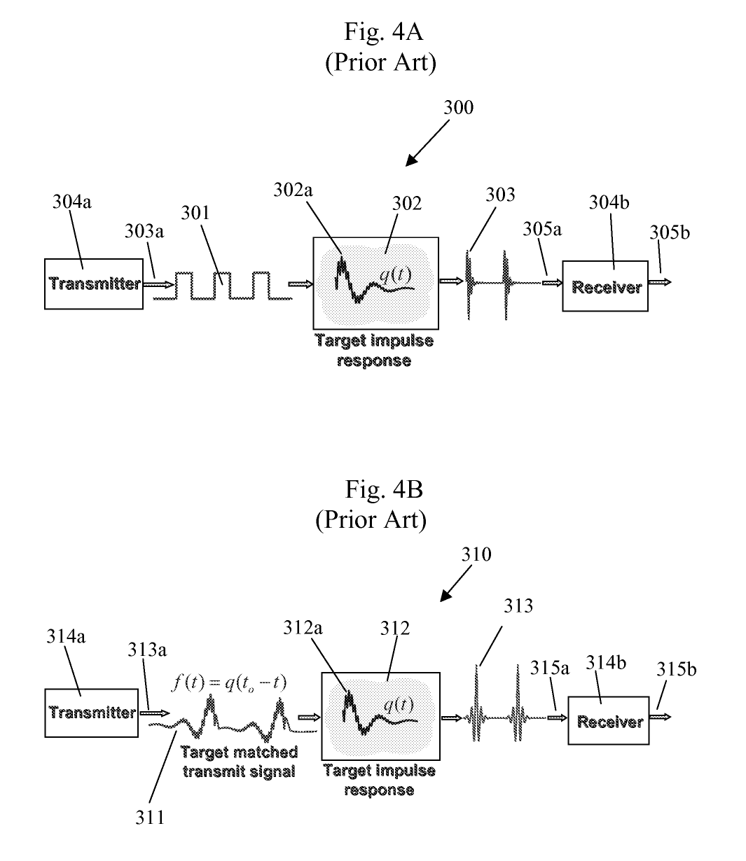

FIG. 4A shows a diagram 300 of a prior art technique. The diagram 300 includes a transmitter 304a, a receiver 304b and a target 302. The transmitter 304a has an output port 303a, and the receiver 304b has an input port 305a and an output port 305b. A computer processor may be programmed to cause the transmitter 304a to transmit a rectangular transmit periodic pulse sequence 301. The rectangular periodic pulse sequence 301 propagates through a medium, such as air, and interacts with the target 302 and the interaction produces a target output response signal 303. The rectangular pulse sequence 301 and/or the output data or characteristics sequence 303 relating thereto can be stored in a computer memory, displayed on computer monitor, or sent out or received via network interfaces.

The response characteristics of the target 302 can be characterized by its impulse response which is q(t) and is marked as 302a.

FIG. 4B shows a diagram 310 of a prior art technique. The diagram 310 shows a transmitter 314a, a receiver 314b, and a target 312. The transmitter 314a has an output port 313a, and the receiver 314b has an input port 315a and an output port 315b. A computer processor can be programmed to cause the transmitter 314a to transmit a sequence of target matched waveform signals q(tₒ−t) marked 311. The sequence of waveform signals 311 are generated from a target impulse response waveform q(t) marked 312a, and a target output response waveform sequence 313. The target matched transmit waveform sequence 311 when it interacts with the target 312 through 312a generates a target output response 313, which is larger than the target output response 303 for the rectangular transmit waveform signal 301 in FIG. 4A. However, the transmit sequence 311 does not possess the rectangular pulse-like property of the transmit waveform 301 in FIG. 4A, and therefore, practically speaking is more difficult to generate and/or to transmit. The sequence of waveform signals 311 and/or data or characteristics relating thereto can be stored in a computer memory, displayed on computer monitor, or sent out or received via network interfaces.

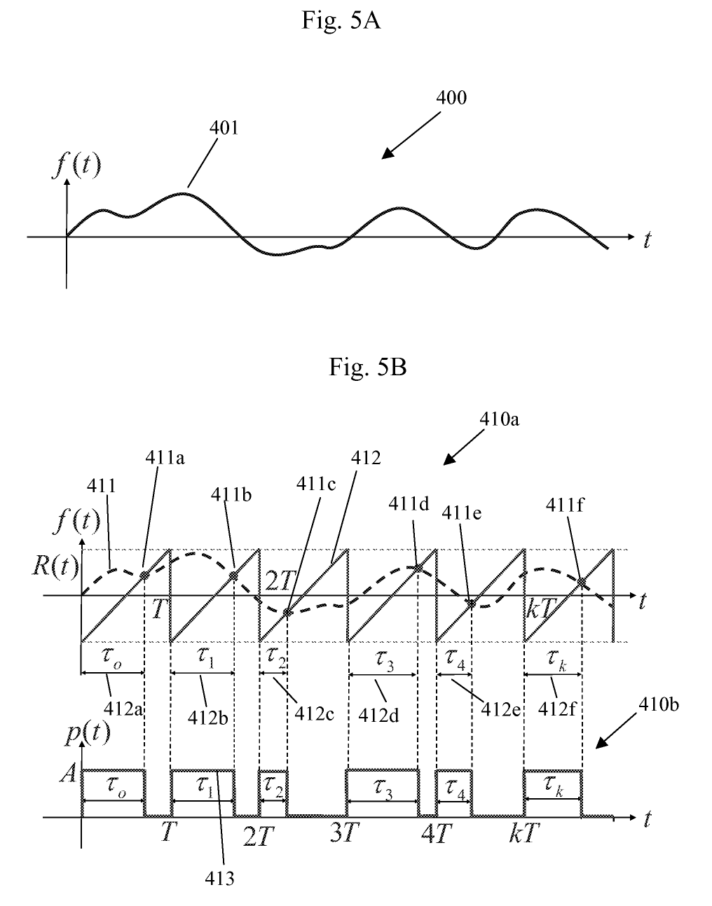

The target impulse response waveform of target 102, not shown in FIG. 2, as well as the impulse response waveform 202a in FIG. 3, the impulse response waveform 302a in FIG. 4A, and the impulse response waveform 312a in FIG. 4B, in this example, are the impulse responses for the same target and thus are the same impulse response. The target matched transmit sequence 311 in FIG. 4B is a sequence of a plurality of the target matched transmit waveforms or signals 201 shown in FIG. 3. The target output response sequence 313 in FIG. 4B is a sequence of a plurality of the target output response 203 in FIG. 3. FIG. 5B shows a PWM (pulse width modulation) sequence, in accordance with an embodiment of the present invention, corresponding to a continuous transmit signal ƒ(t), marked 401 and shown in FIG. 5A and by the dotted line 411 in FIG. 5B. The transmit signal can be any optimum waveform such as target matched waveform 201 in FIG. 3, or those generated using any other optimality criterion such as described in U.S. patent application Ser. No. 11/623,965, filed Jan. 17, 2007, Ser. No. 11/681,218, filed Mar. 2, 2007, and Ser. No. 11/747,365, filed May 11, 2007. A ramp signal R(t), marked 412, shown in FIG. 5B given by

$$R ( t ) = \frac{2 ( t - kT )}{T} - 1 , kT < t < ( k + 1 ) T , k = 0 , \pm 1 , \pm 2 , … \qquad ( 1 )$$

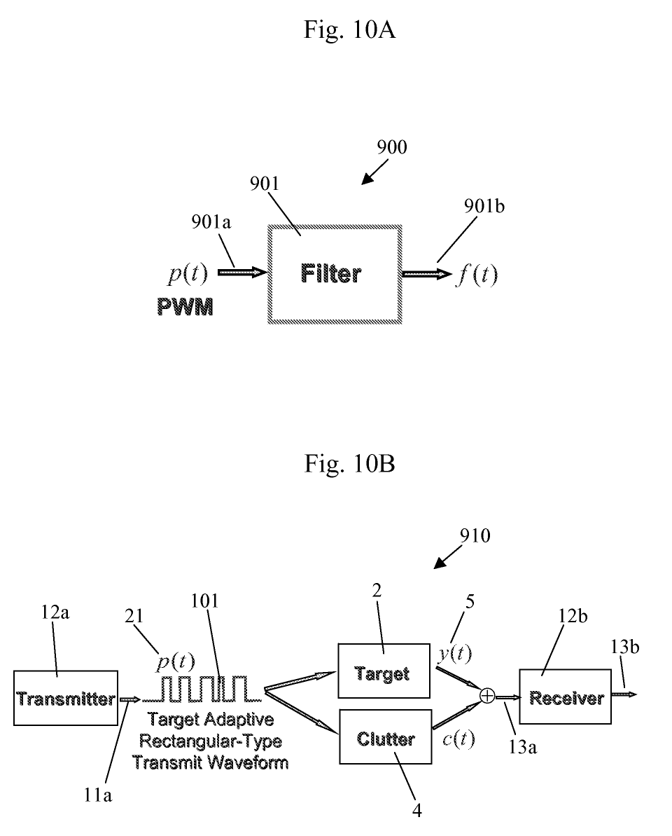

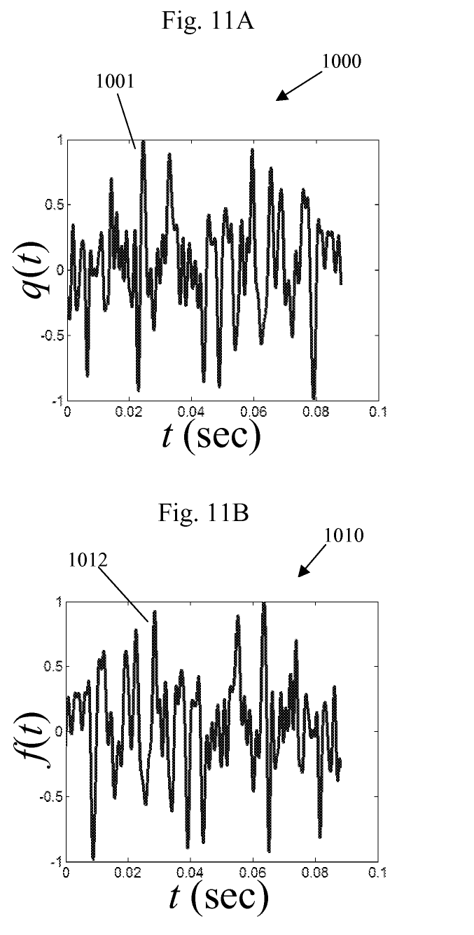

is used to intersect with the first signal or pre-transmit signal ƒ(t) marked by the dotted line 411 in FIG. 5B, or as 401 shown in FIG. 5A. The ramp signal R(t) intersection with the first signal or pre-transmit signal ƒ(t) generates a sequence of intersection points that decide the individual pulse durations τₖ as shown in FIG. 5B. A pulse width modulation (PWM) signal p(t) so generated is marked 413 and shown in FIG. 5B. The computer processor 16 of FIG. 1, can form the pulse width modulation (PWM) signal p(t) and can cause the signal p(t) to be transmitted from transmitter/receiver 12 out to target 4, after applying appropriate chip modulation as necessary, as shown in new FIG. 10B. The pulse width modulation signal p(t) can be stored in memory 18, which may be computer memory.

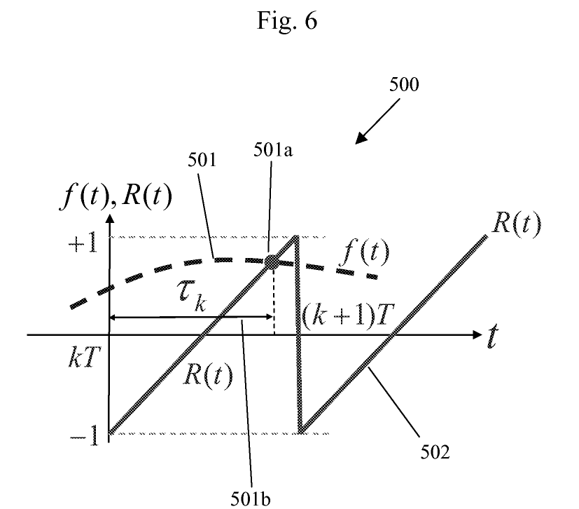

In FIG. 6, the unknown τₖ represents the time required for the ramp R(t) to increase from −1 to the signal level ƒ(kT+τₖ). From FIG. 6, we have at t=kT+τₖ,

$$\frac{2 {τ}_{k}}{T} - 1 = f ( kT + {τ}_{k} ) \to {τ}_{k} = \frac{T ( 1 + f ( kT + {τ}_{k} ) )}{2} \qquad ( 2 )$$

and this procedure results in PWM signal p(t) marked 413 and shown in FIG. 5B. Notice that the PWM signal p(t) shown in FIG. 5B is similar to the traditional rectangular pulsing scheme of the prior art shown in FIG. 4A, except that the pulse durations here are determined by the intersection points τₖ, and they vary here depending on the response characteristics of the pre-transmit signal ƒ(t). Let pre-transmit signal ƒ(t) represent an optimally matched transmit signal corresponding to a target with impulse response q(t) that is also band-limited in the frequency domain, and p(t) be its PWM signal as in FIG. 5B. To determine the Fourier transform of p(t), we can use a well known quasi-static expansion of p(t) in terms of ƒ(t) (See Z. Song, D. V. Sarwate, “The Frequency Spectrum of Pulse Width Modulated Signals”, Elsevier, Signal Processing, Vol. 83, pp. 2227-2258, 2003. and D. C. Youla, “An Exact Pseudo-Static Time-Domain Theory of Natural Pulse Width Modulation”, Submitted to Signal Processing, January 2008, Revised May 2008).

However, with

$${ω}_{c} = \frac{2 π}{T} ,$$

we also have a Fourier series-like representation for p(t) (details omitted)

$$\begin{matrix}p ( t ) = {p}_{o} ( t ) + \frac{f ( t )}{2} + \\ 2 {\sum }_{k = 1}^{∞} \frac{sin ( π kf ( t ) / 2 )}{π k} cos \{ k [ \begin{matrix}{ω}_{c} ( t - T / 2 ) - \\ π f ( t ) / 2\end{matrix} ] \} \\ = {p}_{o} ( t ) + \frac{f ( t )}{2} + \\ {{\sum }_{k = 1}^{∞} \frac{\begin{matrix}sin \{ k [ {ω}_{c} ( t - T / 2 ) ] \} - \\ sin \{ k [ {ω}_{c} ( t - T / 2 ) - π f ( t ) ] \}\end{matrix}}{π k}}_{\underbrace{Nonlinear distortion terms = {\sum }_{k} {x}_{k} ( t )}} .\end{matrix} \qquad ( 3 )$$

Observe that the PWM signal p(t) in equation (3) contains the first signal or pre-transmit signal ƒ(t) along with distortion terms marked

$${\sum }_{k} {x}_{k} ( t )$$

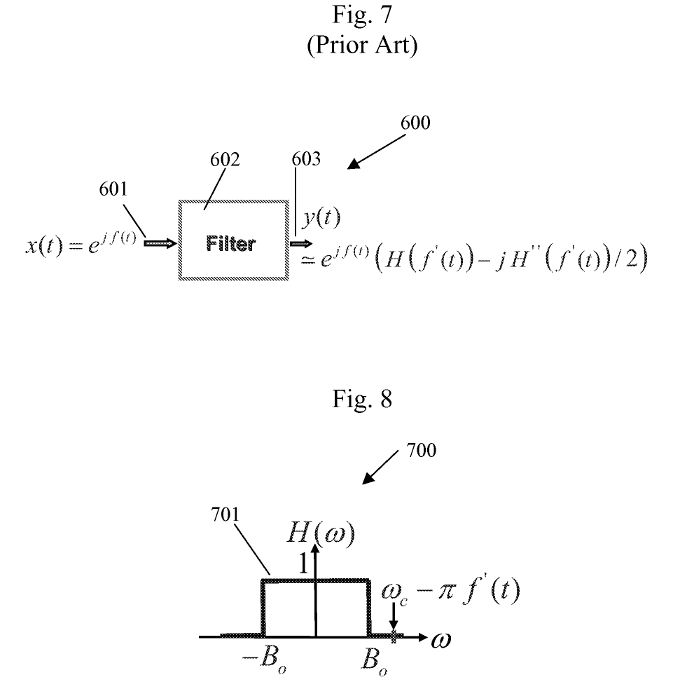

there, that also depend on the pre-transmit signal ƒ(t) (See H. S. Black, Modulation Theory, Chapter 17, Van Nostrand, New York, 1953). To obtain a filter (which will have the characteristics of a target) that minimizes distortions on the PWM signal, we can use the general results of non-linear modulation through a linear filter such as a filter 602 shown in FIG. 7. The linear filter can be a low pass filter having a transfer function such as shown in FIG. 8. It can be shown that input non-linear modulation when passed through a linear filter with transform function H(ω) as in FIG. 8 generates the output signal y(t) whose dominant terms are given by

$$y ( t ) ≃ {e}^{j f ( t )} ( H ( {f}^{′} ( t ) ) - \frac{j}{2} {H}^{′′} ( {f}^{′} ( t ) ) ) . \qquad ( 4 )$$

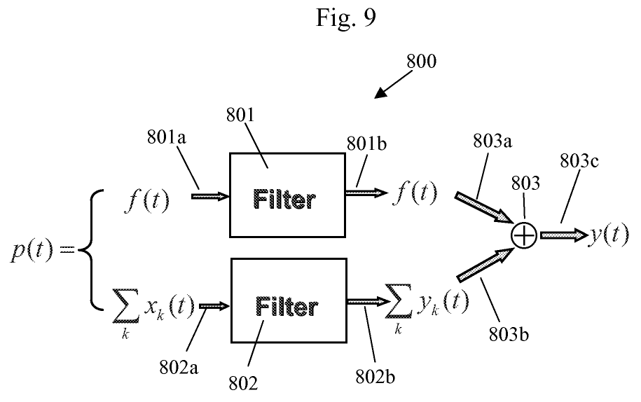

In Equation (4), ƒ′(t) represents the derivative of ƒ(t) and H′(.) represents the second derivative of H(.). FIG. 9 shows the PWM signal in equation (3) applied to the same low-pass filter marked 801 and 802 having a common transfer function of H(ω) and bandwidth Bₒ as in FIG. 8. The undistorted output, which is the original low-pass pre-transmit signal ƒ(t), is combined with output distortions sum of

$${\sum }_{k} y ( t )$$

as shown there. Applying equation (4) to FIG. 8. we obtain the output due to a typical distortion term

xₖ(t)=sin {k(ω_{c}(t−T/2)−πƒ(t))} (5)

to be

yₖ(t)=xₖ(t)H(k(ω_{c}−πƒ′(t))). (6)

Clearly from equation (6), the output distortion terms will be absent if

ω_{c}−πƒ′(t)>Bₒ (7)

since in that case all distortion terms get eliminated provided the filter having a transform function H(ω) is low pass with bandwidth Bₒ as shown in FIG. 8.
Also Bernstein's inequality for bandlimited signal gives

$${sup}_{t} \vert \frac{d f ( t )}{d t} \vert \leq {B}_{o} {sup}_{t} \vert f ( t ) \vert < {B}_{o} \qquad ( 8 )$$

and substituting equation (8) into equation (7) we obtain

$${ω}_{c} = \frac{2 π}{T} > ( π + 1 ) {B}_{o} , \qquad ( 9 )$$

i.e., with sufficiently high sampling rate, the distortions can be made zero and this results in the pre-transmit signal recovery as shown in FIG. 10A. Identical filters 801 and 802 are meant here as a substitute for the target (i.e. the target has the characteristics of filter 801 or 802, since 801 and 802 are identical), and if the target possesses low-pass frequency characteristics as in FIG. 8, then for PWM input signal p(t), only the undistorted original pre-transmit signal part ƒ(t) is retained, and since it is target matched, upon interacting with the target results in larger target output signal.

FIG. 5A shows a graph 400. The graph 400 includes a first signal or pre-transmit signal waveform ƒ(t) labeled 401 graphed versus time. The pre-transmit signal can be any optimum waveform such as target matched waveform signal ƒ(t)=q(tₒ−t) marked 201 in FIG. 3, or those generated using any other optimality criterion such as described in U.S. patent application Ser. No. 11/623,965, filed Jan. 17, 2007, Ser. No. 11/681,218, filed Mar. 2, 2007, and Ser. No. 11/747,365, filed May 11, 2007. A computer processor may be programmed to cause a transmitter or transmitter/receiver to transmit the pre-transmit signal or target matched transmit waveform 401 as a transmit signal towards a target.

In accordance with an embodiment of the present invention, a Pulse Width Modulation (PWM) method is used to convert the target matched waveform signal 401 which is the same as 411 in FIG. 5B (or pre-transmit signal) into a rectangular pulse non-periodic ON-OFF type waveform signal 413 in FIG. 5B that is transmitted from the transmitter/receiver 12. The Pulse Width Modulation method may be implemented by computer processor 16 in FIG. 1. FIG. 10B shows the PWM signal p(t) transmitted out from the transmitter/receiver 12 towards the target 2 and a target response signal 5 received by the transmitter/receiver 12.

FIG. 5B shows a diagram 410 which includes a graph 410a and a graph 410b. The graph 410a includes an x-axis labeled t for time, and a y-axis. A time signal ƒ(t) labeled 411 and a ramp signal R(t), labeled 412, are shown graphed versus time in graph 410a. The time signal ƒ(t), labeled 411, has a dashed line and is the same as 401 in FIG. 5A. The computer processor 16 of FIG. 1, may be programmed to generate and cause the transmitter/receiver 12 to transmit the pulse width modulated (PWM) time signal p(t) towards a target, such as target 2. The time signal ƒ(t), p(t), and the ramp signal R(t) and/or data or characteristics relating thereto can be stored in memory 18, displayed on computer monitor 20, or sent out or received via network interfaces 14.

In graph 410b of FIG. 5B, a rectangular non-periodic waveform signal p(t), also labeled 413, is shown graphed versus time. The computer processor 16 may be programmed to cause the transmitter/receiver 12 to transmit the time signal p(t). The time signal p(t) and/or data or characteristics relating thereto can be stored in memory 18, displayed on computer monitor 20, or sent out or received via network interfaces 14.

The waveform 411 or time signal ƒ(t) is the same as the transmit waveform signal ƒ(t) marked 401 shown in FIG. 5A. To generate a pulse width modulated waveform, p(t) of an embodiment of the present invention, that is suitable as a transmit waveform signal, the computer processor 16 is programmed to employ a method to determine intersection points between the waveform signal 411 and ramp signal R(t), marked 412, of period T as in equation (1). The intersection points generated by the computer processor 16 are 411a, 411b, 411c, 411d, 411e and 411f, and are shown in graph 410a of FIG. 5B. The first intersecting point 411a occurs at a distance τₒ marked 412a from the origin of the first segment of the ramp signal R(t), and during that duration the rectangular non-periodic waveform signal p(t) remains at a high level marked A. For the rest of the period (0,T), i.e. other than the segment 412a, the non-periodic waveform signal p(t) is at level zero. Similarly, the second intersecting point 411b occurs at a distance τ₁ marked 412b from the origin of the second segment of the ramp signal, and during that duration the rectangular non periodic waveform signal p(t) remains at the same high level marked A. The non-periodic waveform signal p(t) is at level zero for the rest of the time within that period (T,2T). This procedure is repeated by the computer processor 16 for the third intersecting point 411c, for the fourth intersecting point 411d, for the fifth intersecting point 411e, and in general for the (k+1)^{th} intersection point 411f, the details of which are shown in FIG. 6. This procedure results in the computer processor 16 forming a rectangular pulse width modulated, ON-OFF type non-periodic waveform p(t) marked 413 in FIG. 5B that can be transmitted out via transmitter/receiver 12 instead of the non-pulse like waveform time signal or pre-transmit signal ƒ(t), labeled as 411. The constant level A of the rectangular non periodic waveform signal or pulse-like waveform p(t), which exist for part of the waveform p(t) or signal 413 can be used to adjust the power level of the signal p(t).

FIG. 6 shows a graph 500. The graph 500 includes an x-axis labeled t for time, and y-axis labeled ƒ(t), R(t) that indicate a portion of the time signals ƒ(t) marked 501, and the ramp signal R(t) marked 502, respectively. The graph 500 shows a portion of the signals ƒ(t) and R(t) shown as signals 411 and 412, respectively, in FIG. 5B, during the time interval (kT,(k+1)T). During that time interval, signal 501 and the ramp signal 502 intersect at a point 501a that occurs at a distance τₖ marked 501b from the origin of that segment of the ramp signal, and it is related to the original waveform signal ƒ(t) or 501 as given by equation (2). During that duration τₖ the rectangular non periodic waveform signal p(t) in FIG. 5B remains at the high level or amplitude marked A and the amplitude for p(t) is zero for the rest of the time within that period (kT,(k+1)T).

The rectangular pulse-like, pulse width modulated, non-periodic waveform p(t) marked 413 in FIG. 5B is related to the original waveform ƒ(t) marked 411 in FIG. 5B through the nonlinear relation shown in equation (3), that contains the original waveform ƒ(t) labeled as 411, as well as nonlinear distortion terms as marked there.

FIG. 7 shows a diagram 600. The diagram 600 shows a filter 602. The filter 602 has an input port 601 and an output port 603. The filter 602 has a transfer function of H(ω). When a nonlinear signal x(t)=e^{jƒ(t)} is applied at the input port 601 to the filter 602, the filter 602 generates an output y(t) at its output port 603 as given in equation (6). The filter 602 may be a low pass filter with a transfer function H(ω) as shown in FIG. 8. The filter 602 may represent a target, such as target 2, in which case the output shows the effect due to the nonlinear distortion terms at the input port 601 of the filter 602 (or target) that is present when transmitting the rectangular ON-OFF type PWM signal p(t).

FIG. 8 shows a diagram 700. The diagram 700 includes an x-axis labeled ω for frequency, and y-axis labeled H(ω) to indicate a low pass filter transfer function with pass band in the frequency region (−Bₒ,Bₒ). and another frequency point beyond Bₒ, marked ω_{c}−πƒ′(t).

FIG. 9 shows a diagram 800. The diagram 800 shows filters 801 and 802. The filters 801 and 802 are typically identical and they both have the same transfer function. Filter 801 may have an input port 801a and an output port 801b. Filter 802 may have an input port 802a and an output port 802b. An input time signal p(t) that represents the pulse width modulation signal has two components marked ƒ(t) and

$${\sum }_{k} {x}_{k} ( t )$$

as shown in equation (3). The effect of the filter 801 (modeling for a target) on the first component ƒ(t) is shown by the signal at the output port 801b, and the effect of the second component

$${\sum }_{k} {x}_{k} ( t )$$

on the filter 802 (modeling for the same target) is shown by the signal at the output port 802b. The first component time function ƒ(t) may be supplied at input port 801a into filter 801. The time function ƒ(t) is acted on by filter 801 (or by a target with the same characteristic response) to form an undistorted output ƒ(t) at output port 801b.

The second component time function marked

$${\sum }_{k} {x}_{k} ( t )$$

may be input at input port 802a into filter 802. The function

$${\sum }_{k} {x}_{k} ( t )$$

may be acted on by filter 802 to form a modified output at output port 802b of the form

$${\sum }_{k} {y}_{k} ( t ) .$$

The output signals ƒ(t) and

$${\sum }_{k} {y}_{k} ( t )$$

on output ports 801b and 802b, are supplied to input ports 803a and 803b, respectively, of signal combiner 803. The output signals ƒ(t) and

$${\sum }_{k} {y}_{k} ( t )$$

are combined by signal combiner 803 to form a combined signal y(t) at output port 803c that represents the effect of the filter on the overall input signal p(t).

The input signals ƒ(t) and

$${\sum }_{k} {x}_{k} ( t )$$

are part of the pulse width modulation signal p(t) that may be formed and/or supplied by computer processor 16 and/or by transmitter/receiver 12. The pulse width modulation signal p(t) may be saved in memory 18 and/or displayed on computer monitor 20. The signals ƒ(t) and

$${\sum }_{k} {x}_{k} ( t )$$

are not generated separately, and they are shown here to illustrate the effect of the filter (either filter 801 or 802, where 801 and 802 are identical) on these input signal components.

The sum of the input signals ƒ(t) and

$${\sum }_{k} {x}_{k} ( t )$$

is the rectangular pulse-like, pulse width modulated, non-periodic waveform p(t) marked 413 of FIG. 5B given by equation (3). The input at input port 801a of the filter 801 is ƒ(t) and the input at input port 802a of the filter 802 is the remaining distortion terms

$${\sum }_{k} {x}_{k} ( t )$$

in equation (3). When the filter 801 has the low-pass transfer function as in FIG. 8, it passes the low-pass input signal ƒ(t) undistorted to its output as shown at 801b, and the distortion terms at 802a generate the output at 802b. The outputs at output ports 801b and 802b are combined by signal combiner 803 to give the combined output y(t) at output port 803c of the signal combiner 803 and y(t) represents the effect of filtering the pulse width modulated non-periodic waveform p(t) through low pass filters 801 and 802 each having transfer function H(ω). If the original signal ƒ(t) satisfies the bandwidth inequality condition given by equation (7), then as equations (3)-(6) show the frequency content of the distortion terms at the output 802b fall outside the point marked ω_{c}−πƒ′(t) in FIG. 8 and the frequency content of terms outside this point tend to be zero. As a result the distortion terms at 802b tend to be zero. The filters 801 and 802 may represent a target, such as target 2 in FIG. 1, in which case FIG. 9 illustrates the effect of PWM pulse sequence interaction with the target, and only the original pre-transmit signal ƒ(t) interacts with the target. The signal combiner 803 is not a physical object but merely represents the fact that the pre-transmit signal ƒ(t) and the distortion output

$${\sum }_{k} {y}_{k} ( t )$$

combine together to form y(t). If the input signal has band-pass characteristics, or any other finite band characteristics, an appropriate band-pass filter will recover the undistorted term from the corresponding PWM signal.

FIG. 10A shows a diagram 900. The diagram 900 shows a filter 901. The filter 901 may represent a target. The filter includes an input port 901a and an output port 901b. The signal p(t) is supplied to the input port 901a. If the original signal ƒ(t) contained in the PWM input 901a satisfies the inequality condition given by equation (7), then as equations (3)-(6) show the frequency content of the distortion terms at output port 802b in FIG. 9 fall outside the point marked ω_{c}−πƒ′(t) in FIG. 8 and they tend to be zero. As a result the rectangular pulse width modulated, non-periodic waveform p(t) at the input port 901a when applied to low pass filter 901 with frequency characteristics as in 701 (or a target with the same characteristics) in FIG. 8 generates an undistorted output ƒ(t) at output port 901b, provided p(t) satisfies the bandwidth inequality condition given by equation (7).

FIG. 10B shows transmission of pulse width modulated signal 21 out to target and receiving response in accordance with an embodiment of the present invention. FIG. 10B shows a transmitter 12a and a receiver 12b which may be part of transmitter/receiver 12 of FIG. 1. The transmitter 12a includes an output port 11a and the receiver 12b includes an input port 13a and an output port 13b.

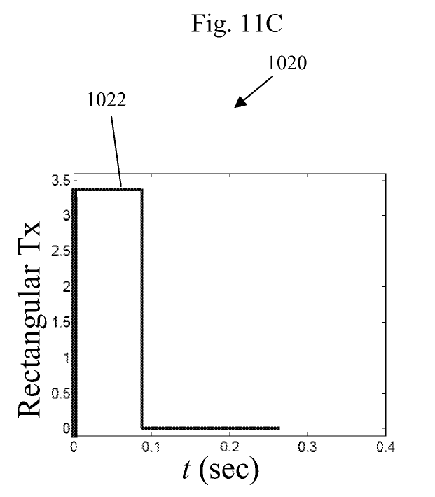

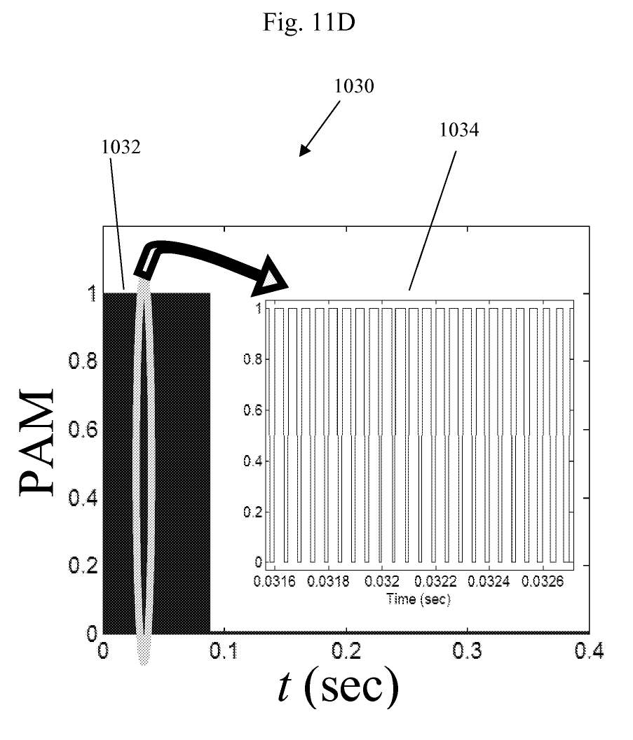

FIG. 11A shows a diagram 1000 of a given target impulse response waveform q(t), marked 1001. The diagram 1000 shows an x-axis labeled t for time in seconds, and y-axis showing real amplitude values.

FIG. 11B shows a diagram 1010 of a target matched transmit waveform q(tₒ−t) marked 1012 that is obtained from target output response waveform signal q(t) 1001 by time-reversing it to generate q(−t) and shifting it to the right by the duration of the original waveform tₒ to obtain q(tₒ−t). The diagram 1010 shows an x-axis labeled t for time in seconds, and y-axis showing real amplitude values.

FIG. 11C shows a diagram 1020 of a given rectangular waveform marked 1022 of the same duration as the target impulse response waveform signal 1001, q(t). The diagram 1020 shows an x-axis labeled t for time in seconds, and y-axis showing real amplitude values.

FIG. 11D shows a diagram 1030 of a rectangular pulse width modulated non-periodic waveform 1032 generated using a pulse width modulation method applied to the target matched transmit waveform signal marked q(tₒ−t), 1012 in FIG. 11B. Diagram 1034 shows a close up of a portion of 1032. The diagram 1030 shows an x-axis labeled t for time in seconds, and y-axis showing real amplitude values.

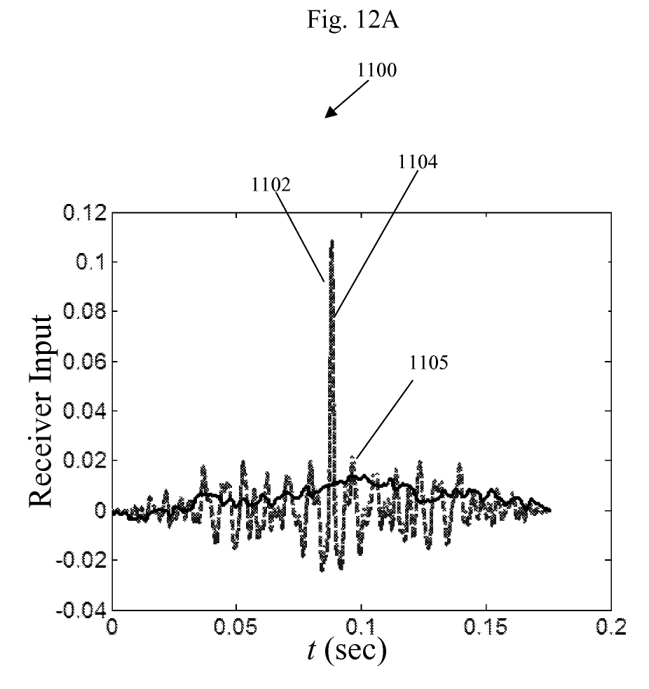

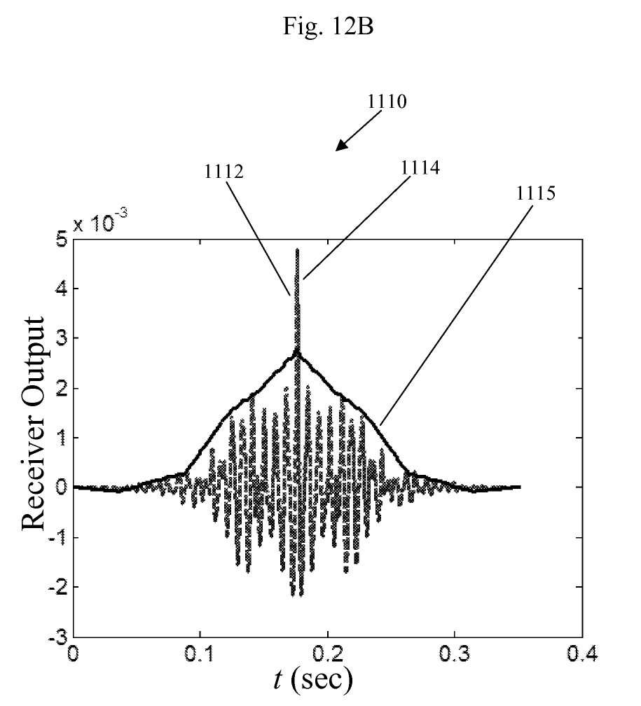

FIG. 12A shows a diagram 1100 of three target output responses (also called receiver input signals) for three transmit signals. The first target output response a signal or waveform 1102, marked by the dashed line, represents the response of the target 2 due to the target matched transmit signal waveform q(tₒ−t), marked 1012 in FIG. 11B. The second target output response signal or waveform 1104 marked by the dotted line, represents the response of the target 2 due to the pulse width modulated and target matched transmit signal or waveform marked 1032 in FIG. 11D of an embodiment of the present invention in FIG. 5B. The third target output response signal or waveform 1105 marked by the solid line represents the response of the target 2 due to the rectangular pulse transmit signal or waveform marked 1022 in FIG. 11C of the prior art technique of FIG. 2. The diagram 1100 shows an x-axis labeled t for time in seconds, and y-axis showing real amplitude values.

Observe that the first target output response 1102 due to the target matched transmit signal or waveform q(tₒ−t) 1012 and the second target output response 1104 due to the rectangular shaped pulse width modulated transmit signal waveform marked 1032 of an embodiment of the present invention are identical, and hence for the purpose of actual transmission, the target matched transmit signal or waveform q(tₒ−t), 1012 of FIG. 11B may be replaced with the rectangular shaped pulse width modulated transmit signal waveform marked 1032 of FIG. 11D at the transmitter/receiver 12 in FIG. 1. Moreover, the first and second target output responses 1102 and 1104 have dominant peaks compared to the target output response 1105 due to the rectangular transmit signal or waveform 1022 of the prior art.

FIG. 12B shows a diagram 1110 of three receiver outputs due to three different receiver input waveforms in FIG. 12A using their respective matched filters. Waveform 1112 marked by the dashed line represents the response of matched filtering the waveform 1102 in FIG. 12A. Similarly the waveform 1114 marked by the dotted line represents the response of matched filtering the waveform 1104 of an embodiment of the present invention in FIG. 12A. Finally, the waveform 1115 marked by the solid line represents the response of matched filtering the waveform 1105 of the prior art in FIG. 12A. The diagram 1110 shows an x-axis labeled t for time in seconds, and y-axis showing real amplitude values.

The target matched transmit signal waveform q(tₒ−t) 1012 in FIG. 11B generates the target output response signal or waveform 1102 (also called receiver input) of FIG. 12A which in turn generates the receiver output response 1112 of FIG. 12B. The pulse width modulated rectangular-type transmit signal or waveform 1032 of FIG. 11D generates the target output response signal or waveform 1104 of FIG. 12A which in turn generates the receiver output response 1114 of FIG. 12B. Since the receiver outputs 1112 and 1114 respectively of the target matched transmit signal or waveform marked 1012 of FIG. 11B and its pulse width modulated transmit signal waveform marked 1032 of FIG. 11D are identical, for the purpose of transmission the target matched transmit signal waveform q(tₒ−t), marked 1012 in FIG. 11B may be replaced with the pulse width modulated rectangular-type transmit signal waveform 1032 of FIG. 11D. Moreover both the receiver outputs 1112 and 1114 in FIG. 12B have dominant sharp peaks indicating their excellent pulse compression properties compared to the response 1115, due to the rectangular transmit signal waveform marked 1022 in FIG. 11C, that is much wider compared to the other two receiver output responses 1112 and 1114. Once again the equality of receiver outputs 1112 and 1114 of FIG. 12B show that the target matched transmit signal or waveform q(tₒ−t), 1012 of FIG. 11B may be replaced with the rectangular shaped pulse width modulated transmit signal or waveform marked 1032 of FIG. 11D at the transmitter/receiver 12 in FIG. 1. Both the target matched transmit signal 1012 and the pulse width modulated transmit signal 1032 perform superior to the rectangular input transmit signal of the prior art or waveform 1022 of FIG. 11C.

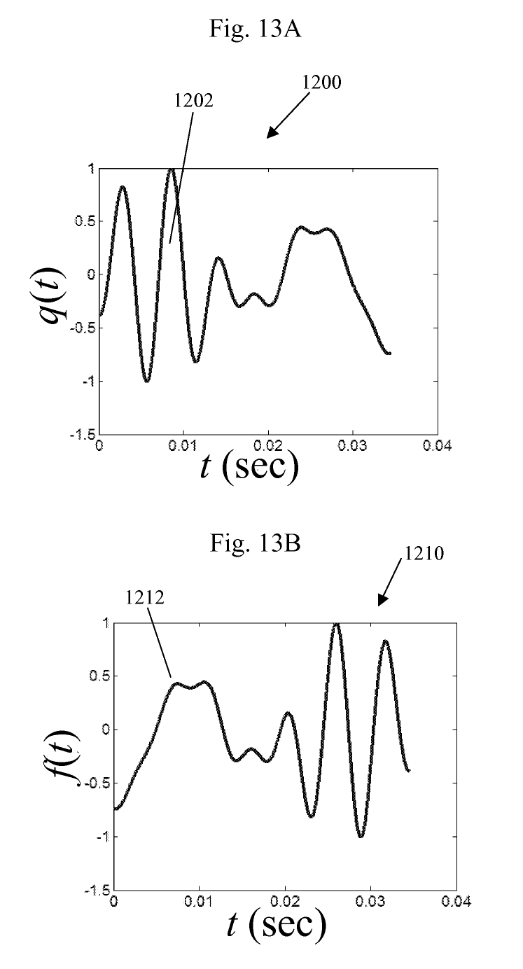

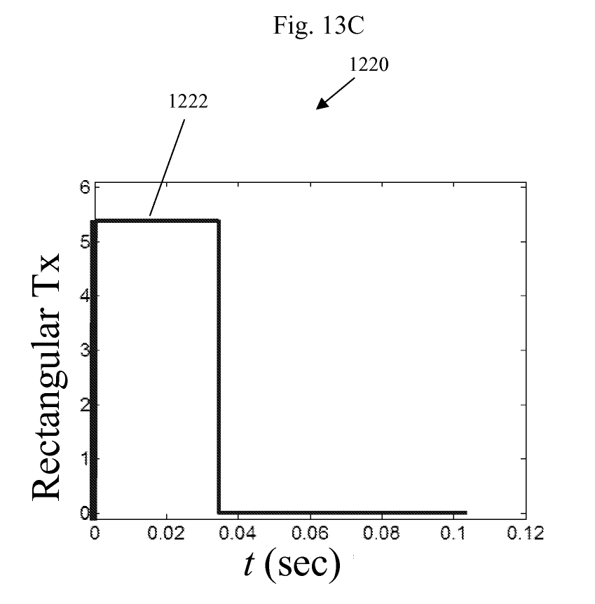

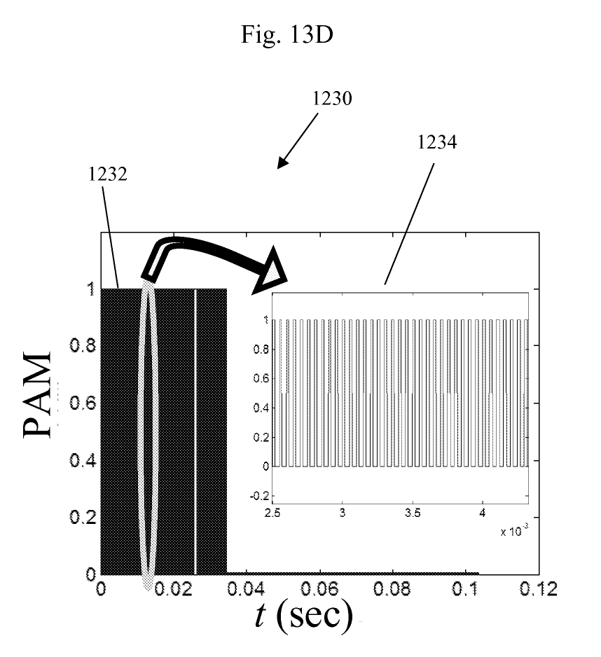

FIG. 13A shows a diagram 1200 of a given target impulse response waveform marked 1202. The diagram 1200 shows an x-axis labeled t for time in seconds, and y-axis showing real amplitude values.

FIG. 13B shows a diagram 1210 of a target matched transmit signal waveform marked 1212 that is obtained from 1202 by time-reversing it and shifting it to the right by the duration of the original waveform. The diagram 1210 shows an x-axis labeled t for time in seconds, and y-axis showing real amplitude values.

FIG. 13C shows a diagram 1220 of a given rectangular transmit waveform marked 1222 of the same duration as the target impulse response 1202. The diagram 1220 shows an x-axis labeled t for time in seconds, and y-axis showing real amplitude values.

FIG. 13D shows a diagram 1230 of a non-periodic pulse width modulated transmit signal or waveform 1232 generated using a pulse width modulation method from the target matched transmit signal waveform marked 1212 in FIG. 13B. Diagram 1234 shows a highlighted portion of 1232. The diagram 1230 shows an x-axis labeled t for time in seconds, and y-axis showing real amplitude values.

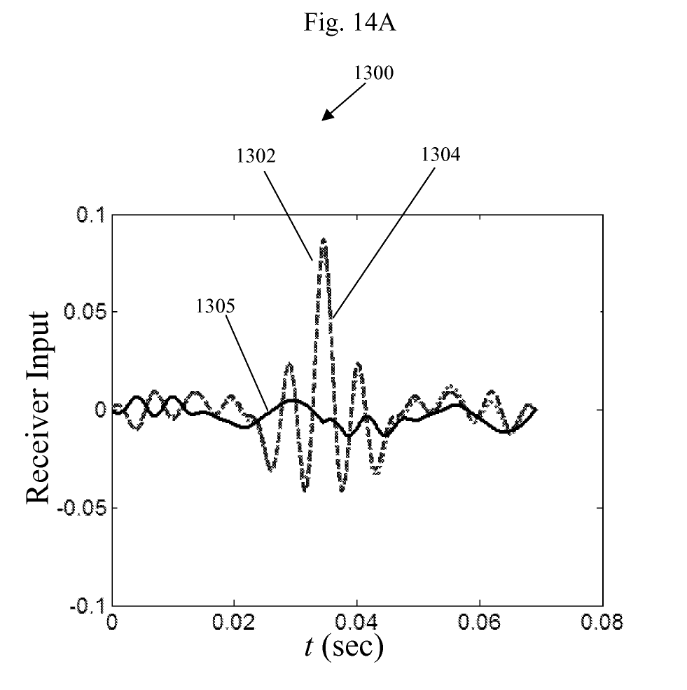

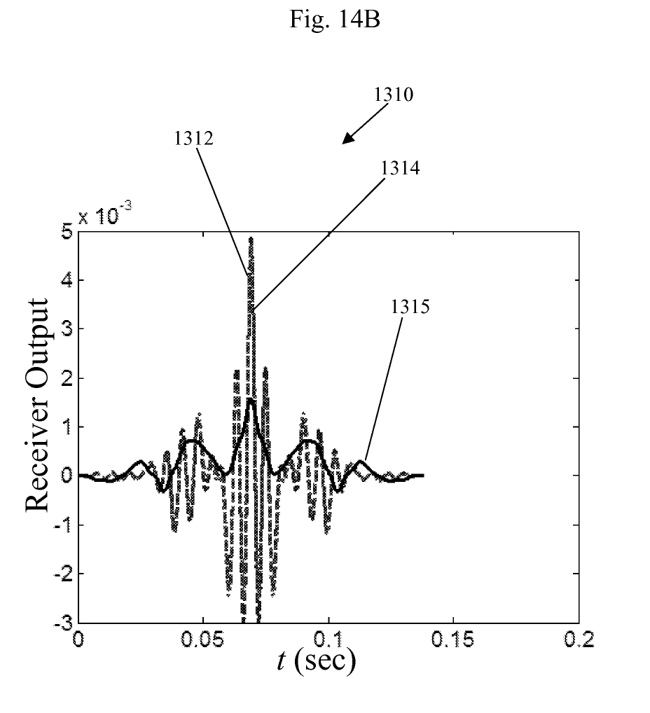

FIG. 14A shows a diagram 1300 of three different target output responses for three different transmit signals from a transmitter/receiver 12 towards the target 2. Waveform 1302 marked by the dashed line represents the target output response of the target 2 due to the target matched transmit signal waveform q(tₒ−t) marked 1212 in FIG. 13B. Waveform 1304 marked by the dotted line represents the target output response due to the pulse width modulated and target matched transmit signal or waveform marked 1232 in FIG. 13D of an embodiment of the present invention. Waveform 1305 marked by the solid line represents the target output response due to the rectangular pulse transmit signal or waveform marked 1222 in FIG. 13C of a prior art technique. The diagram 1300 shows an x-axis labeled t for time in seconds, and y-axis showing real amplitude values.

Observe that the responses due to the target matched transmit signal or waveform 1302 and its pulse modulated transmit signal or waveform marked 1304 are identical and they have dominant peaks compared to the response 1305 due to the rectangular transmit waveform. Hence for the purpose of actual transmission, the target matched transmit signal or waveform q(tₒ−t), 1212 of FIG. 13B may be replaced with the rectangular shaped pulse width modulated transmit signal or waveform marked 1232 of FIG. 13D at the transmitter/receiver 12 in FIG. 1.

FIG. 14B shows a diagram 1310 of three different receiver outputs due to three different transmit signals. The first receiver output signal or waveform 1312, marked by the dashed line, is in response to the target matched transmit signal or waveform 1302. The second receiver output signal or waveform 1314, marked by the dotted line, is in response to the pulse width modulated transmit signal or waveform marked 1304. The third receiver output signal 1315, marked by the solid line is in response to the rectangular transmit waveform. The diagram 1310 shows an x-axis labeled t for time in seconds, and y-axis showing real amplitude values.

The target matched transmit signal waveform q(tₒ−t), marked 1212 in FIG. 13B generates the target output response signal or waveform 1302 of FIG. 14A which in turn generates the receiver output response 1312 of FIG. 14B. Similarly the pulse width modulated rectangular-type transmit waveform 1232 of FIG. 13D generates the target output response signal or waveform 1304 of FIG. 14A which in turn generates the receiver output response 1314 of FIG. 14B. Since receiver responses 1312 and 1314, respectively of the target matched transmit signal or waveform 1212 of FIG. 13B and its pulse width modulated transmit signal or waveform marked 1232 of FIG. 13D are identical, for the purpose of transmission the target matched transmit signal or waveform q(tₒ−t), marked 1212 in FIG. 13B may be replaced with the pulse width modulated rectangular-type transmit signal or waveform 1232 of FIG. 13D. Moreover both the receiver outputs 1312 and 1314 in FIG. 14B have dominant sharp peaks indicating their excellent pulse compression properties compared to the receiver output response 1315, due to the rectangular transmit signal waveform marked 1222 in FIG. 13C. The receiver output 1315 is much wider compared to the receiver outputs 1312 and 1314. Once again the equality of outputs 1312 and 1314 in FIG. 14B show that the target matched transmit signal or waveform q(tₒ−t), 1212 of FIG. 13B may be replaced with the rectangular shaped pulse width modulated transmit signal or waveform marked 1232 of FIG. 13D at the transmitter/receiver 12 in FIG. 1, and they both perform superior to the rectangular transmit signal or waveform 1222 of FIG. 13C.

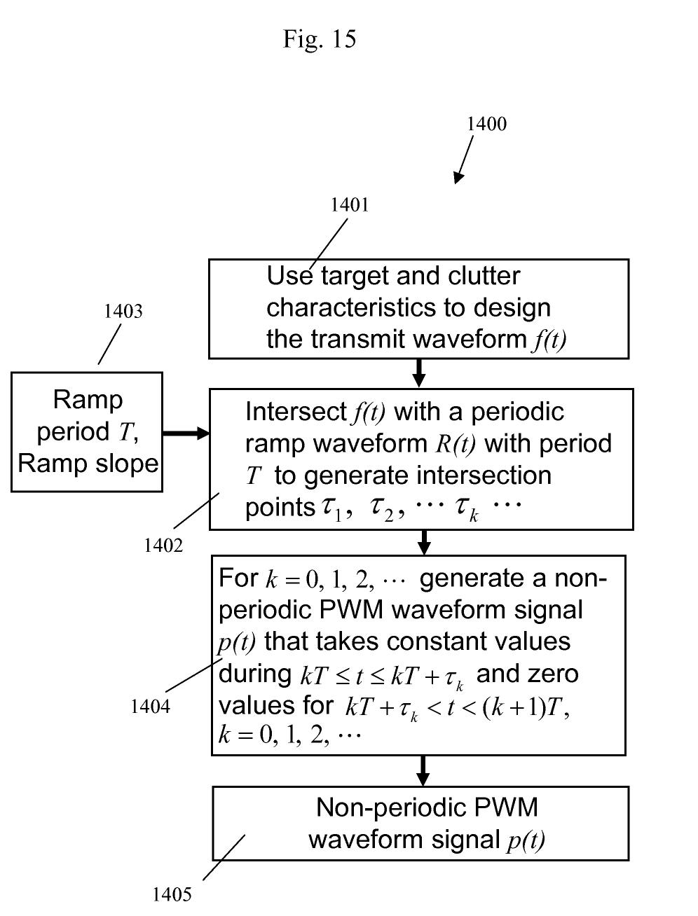

FIG. 15 shows a flowchart 1400 of a method of use of the apparatus 10 of FIG. 1 in accordance with one embodiment of the present invention. At step 1401 the computer processor 16 is programmed to cause the transmitter/receiver 12 to send out an impulse signal. The impulse signal interacts with the target 2 and with clutter 4. The transmitter/receiver 12 receives return signals back from the target 2 and the clutter 4. The computer processor 16 may use the return signals to determine the target and clutter characteristics such as its power spectrum, or it may use prior knowledge about the target and clutter characteristics. The target and clutter characteristics can also be supplied from computer memory 18, from a user via user interactive device 22, or via network interfaces 14. The target characteristics may be in the form of a target impulse response function, q(t) in the time domain as in 312a of FIG. 4B or its frequency transfer function, and the clutter characteristics may be in the form of the clutter power spectral density function in the frequency domain.

After the computer processor 16 is supplied with and/or determines the target and clutter characteristics of target 2 and clutter 4, the computer processor 16 generates an optimum pre-transmit waveform ƒ(t) marked 411 in FIG. 5B such as a matched target response waveform q(tₒ−t) as shown in 311 in FIG. 4B or 401 in FIG. 5A. In one or more embodiments of the present invention, the transmit waveform is the matched target impulse response generated by time-reversing the target impulse response and shifting it to the right by a desired amount. In general, the pre-transmit waveform ƒ(t) can be generated by the computer processor 16 by other means such as by maximizing the ratio of the target output power to total received clutter power at a receiver input of the transmitter/receiver 12 and depending on other criterion such as causality as given by equations (14)-(18).

At step 1402, the computer processor 16 generates a periodic ramp waveform R(t) such as 412 in FIG. 5B by retrieving a ramp waveform period T and a ramp slope such as satisfying equation (9) from the memory 18 through step 1403, and superimposes the ramp waveform onto the pre-transmit signal ƒ(t) such as 411 in FIG. 5B to generate a sequence of intersection points such as 411a, 411b, 411c etc. in FIG. 5B. The computer processor 16 may use a mathematical method or technique to superimpose the characteristics or data of the ramp waveform R(t) onto the transmit signal ƒ(t) in computer memory 18.

At step 1404, the computer processor 16 uses these intersection points to generate a non-periodic rectangular pulse width modulated and/or pulse-like signal p(t) as follows: The first intersecting point 411a in FIG. 5B occurs at a distance τₒ marked 412a from the origin of the first segment of the ramp signal R(t) and during that duration the signal p(t) is made to remain at a high level marked A and the signal level of p(t) is at level zero for the rest of the time within that period (0,T). Similarly the second intersecting point 411b occurs at a distance τ₁ marked 412b from the origin of the second segment of the ramp signal, and during that duration the signal p(t) is made to remain at the same high level marked A and the signal level of p(t) is at level zero for the rest of the time within that period (T,2T). This procedure is repeated for the third intersecting point 411c, for the fourth intersecting point 411d, for the fifth intersecting point 411e, and in general for the (k+1)^{th} intersection point marked 411f in FIG. 5B. This procedure results in a pulse width modulated non-periodic waveform p(t) marked 413 in FIG. 5B that can be transmitted in place of the non-pulse like waveform 401 in FIG. 4A.

FIGS. 11A-D and FIGS. 12A-B illustrate the advantage in using a target adaptive pulsing scheme. FIG. 11A shows a target impulse response waveform q(t), FIG. 11B its matched filter response ƒ(t)=q(tₒ−t), FIG. 11C an ordinary rectangular pulse and FIG. 11D shows the PWM signal corresponding to ƒ(t). FIG. 12A shows three different target output responses due to three different transmit signals, including the target output response due to rectangular pulse (solid line) marked 1105, the target output response due to the matched filter waveform ƒ(t)=q(tₒ−t) (dashed line) marked 1102, and the target output response due to the PWM signal corresponding to ƒ(t) (dotted line) marked 1104. FIG. 12B shows the receiver outputs by matched filtering the waveforms in FIG. 12A. From there, the responses due to the target matched transmit signal waveform 1112 and its pulse modulated waveform marked 1114 are identical and has dominant sharp peaks indicating excellent pulse compression properties compared to the response 1115 due to the rectangular waveform that is much wider compared to the other two outputs. Hence for the purpose of actual transmission, the target matched transmit signal or waveform q(tₒ−t), 1012 of FIG. 11B may be substituted by the rectangular shaped pulse width modulated transmit signal or waveform marked 1032 of FIG. 11D at the transmitter/receiver marked 12 in FIG. 1.

FIGS. 13A-D and FIG. 14A-B illustrate another example of target adaptive pulsing scheme. FIG. 13A shows a target impulse response waveform q(t), FIG. 13B its matched transmit signal ƒ(t)=q(tₒ−t), FIG. 13C an ordinary rectangular pulse and FIG. 13D shows the PWM signal of ƒ(t). FIG. 14A shows three different target output responses, one due to the rectangular pulse (solid line) marked 1305, one target output response due to the target matched filter ƒ(t) (dashed line) marked 1302, and out target output response marked 1304 (dotted line) due to the PWM signal in 1232 in FIG. 13D. FIG. 14B shows the receiver outputs by matched filtering the waveforms in FIG. 14A. From there, PWM performance represented by 1314 has essentially has equivalent performance as the target matched filter response in 1312, and hence for the purpose of actual transmission, the target matched transmit signal or waveform q(tₒ−t), 1212 of FIG. 13B may be substituted with the rectangular shaped pulse width modulated signal or waveform marked 1232 of FIG. 13D at the transmitter/receiver marked 12 in FIG. 1.

In summary, a Pulse Width modulation (PWM) method in accordance with an embodiment of the present invention, using the apparatus 10 in FIG. 1 according to the flowchart 1400 in FIG. 15 describes a procedure to convert any waveform to a pulse width modulated non-periodic waveform, and under some general restrictions such as in equation (7), the original waveform can be fully recovered from the PWM waveform through proper filtering. As a result if a target matched transmit signal waveform, or any other appropriate transmit waveform is used as a first signal or pre-transmit signal and is pulse width modulated and transmitted towards a target, under the conditions of equation (7), the target recovers the underlying transmit signal waveform and generates an output through convolution with its impulse response such that the output has larger peak energy, or larger signal to clutter power ratio, compared to any other waveform.

The proposed method of generating pulse width modulated non-periodic waveforms that achieve the same results as a given waveform ƒ(t) using the apparatus 10 in FIG. 1 according to the flowchart 1400 in FIG. 15 can be applied to other pre-transmit waveforms that have been designed, for example, to maximize the target response and minimize clutter response. In this context, two methods for generating suitable pre-transmit waveforms are described below:

For example, the ratio of the target output signal power to the mean clutter power at the receiver input (SCR) can be used to design the pre-transmit waveform as well. Thus with ƒ(t) representing the desired pre-transmit waveform, q(t) the target impulse response waveform, the target output signal at t=tₒ is given by

$$s ( {t}_{o} ) = \frac{1}{2 π} {\int }_{- ∞}^{+ ∞} Q ( ω ) F ( ω ) {e}^{jω {t}_{o}} d ω . \qquad ( 10 )$$

Here Q(ω) and F(ω) represent the Fourier transforms of the target and pre-transmit signals q(t) and ƒ(t) respectively. Similarly with G_{c}(ω) representing the clutter power spectral density in the frequency domain with associated minimum phase transfer function L_{c}(jω) we have

G_{c}(ω)=|L_{c}(jω)|². (11)

This gives the average clutter power at the receiver input to be [S. U. Pillai, K. Y. Li, B. Himed, Space Based Radar Theory & Applications, McGraw Hill, New York, N.Y., December 2007]

$$\begin{matrix}{σ}_{c}^{2} = \frac{1}{2 π} {\int }_{- ∞}^{+ ∞} {G}_{c} ( ω ) {\vert F ( ω ) \vert}^{2} d ω \\ = \frac{1}{2 π} {\int }_{- ∞}^{+ ∞} {\vert {L}_{c} ( jω ) F ( ω ) \vert}^{2} d ω .\end{matrix} \qquad ( 12 )$$

Using (10) and (12), the target to clutter power ratio at t=tₒ equals

$$\begin{matrix}y = \frac{{\vert s ( {t}_{o} ) \vert}^{2}}{{σ}_{c}^{2}} \\ = \frac{\frac{1}{2 π} {\vert {\int }_{- ∞}^{+ ∞} Q ( ω ) F ( ω ) {e}^{jω {t}_{o}} d ω \vert}^{2}}{{\int }_{- ∞}^{+ ∞} {\vert {L}_{c} ( jω ) F ( ω ) \vert}^{2} d ω} \leq \\ \frac{1}{2 π} {\int }_{- ∞}^{+ ∞} {\vert {L}_{c}^{- 1} ( jω ) \vert}^{2} {\vert Q ( ω ) \vert}^{2} d ω \\ = \frac{1}{2 π} {\int }_{- ∞}^{+ ∞} \frac{{\vert Q ( ω ) \vert}^{2}}{{G}_{c} ( ω )} d ω ,\end{matrix} \qquad ( 13 )$$

where we have used Schwarz' inequality. Equality in (13) is realized if and only if the transmit waveform transform F(ω) satisfies

$$F ( ω ) = k \frac{{Q}^{*} ( ω )}{{G}_{c} ( ω )} , \qquad ( 14 )$$

where k is a suitable constant that can be used to adjust the transmit energy level. The waveform ƒ(t) obtained by performing the inverse Fourier transform of equation (14) is another potential candidate for the pre-transmit waveform that is generated at stage 1401 of FIG. 15 and it is supplied to the transmitter/receiver 12 in FIG. 1 for generating the pulse like waveform p(t) at stage 1405 in FIG. 15.

The pre-transmit waveform ƒ(t) obtained as above in equation (14) need not represent a causal (one-sided) waveform. If a causal transmit waveform that is optimum in the sense of maximizing (13) is desired, then it is necessary to process differently. It can be shown that [S. U. Pillai, H. S. Oh, D. C. Youla, and J. R. Guerci, “Optimum Transmit-Receiver Design in the Presence of Signal-Dependent Interference and Channel Noise”, IEEE Transactions on Information Theory, Vol. 46, No. 2, pps. 577-584, March 2000] in that case, let g(t) represent the inverse Fourier transform of L_{c}⁻¹(jω)Q(ω), thus

g(t) [symbol] L_{c}⁻¹(jω)Q(ω), (15)

and let K(ω) represent the Fourier transform of g*(tₒ−t)u(t), where u(t) represents the unit step function that is defined to be unity for t≧0, and zero otherwise. Thus, let

g*(tₒ−t)u(t) [symbol] K(ω). (16)

Then the optimum causal pre-transmit waveform ƒ(t) that maximizes (13) is given by [S. U. Pillai, K. Y. Li, B. Himed, Space Based Radar Theory & Applications, McGraw Hill, New York, N.Y., December 2007]

F(ω)=L_{c}⁻¹(jω)K(ω) (17)

or

ƒ(t)=l_{c,inv}(t)*g*(tₒ−t)u(t) (18)

where l_{c,inv}(t) represents the inverse Fourier transform of L_{c}⁻¹(jω) and *in equation (18) represents the well known convolution operation.

Once again, the causal pre-transmit waveform given by equation (18) is another potential candidate for the pre-transmit waveform that is generated at step 1401 of FIG. 15 and in one embodiment of the present invention it can be supplied to the transmitter/receiver 12 in FIG. 1 for generating the pulse width modulated non-periodic pulse waveform p(t) at stage 1405 in FIG. 15. Other optimum pre-transmit signal or waveform generating methods using other optimality criterion such as described in U.S. patent application Ser. No. 11/623,965 filed Jan. 17, 2007, U.S. patent application Ser. No. 11/681,218 filed Mar. 2, 2007, and U.S. patent application Ser. No. 11/747,365 filed May 11, 2007, which are incorporated by reference herein, are potential candidates for the pre-transmit waveform at step 1401 of FIG. 15. Although these transmit waveforms are impractical to transmit due to their lacking the property of a constant modulus, any of these transmit waveforms can be supplied as a first signal or pre-transmit signal for step 1401 of FIG. 15 and can be used, together with a secondary signal, such as a ramp signal, for generating the pulse width modulated non-periodic waveform signal p(t) at stage 1405 in FIG. 15.

I claim:

1. A method comprising
forming a first signal;
forming a periodic ramp waveform signal with a fixed period and a fixed slope;
overlapping the periodic ramp waveform signal and the first signal to determine a plurality of intersection points;
generating a non-periodic ON-OFF signal using the plurality of intersection points; and
transmitting the non-periodic ON-OFF signal out from a transmitter as a transmit signal towards a target.

2. The method of claim 1 wherein
the non-periodic ON-OFF signal is either at an ON level or an OFF level;
wherein the non-periodic ON-OFF signal while at the ON level is at a constant level;
wherein the non-periodic ON-OFF signal while at the OFF level is at a zero level.

3. The method of claim 2 further comprising
selecting the constant level so that the energy of the non-periodic ON-OFF signal is a desired level.

4. The method of claim 1 wherein
the first signal is comprised of a target matched signal waveform that is obtained by time-reversing a target impulse response signal to obtain a time-reversed response, and then time shifting the time-reversed response by a time constant so as to form the first signal, so that the first signal is a causal signal.

5. The method of claim 1 wherein
the first signal is formed by a computer processor maximizing a ratio of target output signal power of the target to mean clutter power;
wherein the target output signal power is detected at a receiver input and the mean clutter power is detected at a receiver input.

6. The method of claim 5 wherein
the first signal is non-causal.

7. The method of claim 5 wherein
the first signal is causal.

8. A method comprising
receiving a given first signal at a data input device;
using a computer processor to form a non-periodic ON-OFF type signal which is based on the first signal by employing pulse width modulation; and
transmitting the non-periodic ON-OFF type signal out from a transmitter.

9. The method of claim 8 wherein
the first signal is a time-reversed and time shifted version of a target impulse response waveform q(t) and the first signal is given by q(tₒ−t),
where tₒ a time constant by which a time-reversed signal q(−t), of the first signal is shifted so as to make the first signal causal.

10. The method of claim 8 wherein
the first signal is given by an inverse Fourier transform of
$$\frac{{Q}^{*} ( ω )}{{G}_{c} ( ω )} ,$$
where Q*(ω) represents a complex conjugate of a Fourier transform of a target impulse response signal waveform q(t), and G_{c}(ω) represents a clutter power spectral density in the frequency domain.

11. The method of claim 8 wherein
the first signal is given by an inverse Fourier transform of L_{c}⁻¹)K(ω),
wherein L_{c}⁻¹(jω) represents an inverse of a minimum phase function associated with a spectral factorization G_{c}(ω)=|L_{c}(jω)|², and G_{c}(ω) represents a clutter power spectral density in the frequency domain at a receiver input; K(ω) represents a Fourier transform of g*(tₒ−t)u(t), wherein u(t) represents a unit step function that is defined to be unity for t≧0, and zero otherwise, wherein t represents time, tₒ represents a constant time interval, and g(t) represents an inverse Fourier transform of L_{c}⁻¹(jω)Q(ω), wherein Q(ω) represents a Fourier transform of the target impulse response waveform q(t).

12. A computer readable medium comprising computer executable instructions which, when executed by a processor, perform the steps of:
forming a first signal;
forming a periodic ramp waveform signal with a fixed period and a fixed slope;
overlapping the periodic ramp waveform signal and the first signal to determine a plurality of intersection points;
generating a non-periodic ON-OFF signal using the plurality of intersection points; and
transmitting the non-periodic ON-OFF signal out from a transmitter as a transmit signal towards a target.

13. The computer readable medium of claim 12 wherein
the non-periodic ON-OFF signal is either at an ON level or an OFF level;
wherein the non-periodic ON-OFF signal while at the ON level is at a constant level;
wherein the non-periodic ON-OFF signal while at the OFF level is at a zero level.

14. The computer readable medium of claim 12 wherein the computer executable
instructions, when executed by the processor, perform the further steps of:
selecting the constant level so that the energy of the non-periodic ON-OFF signal is a desired level.

15. The computer readable medium of claim 12 wherein
the first signal is comprised of a target matched signal waveform that is obtained by time-reversing a target impulse response signal to obtain a time-reversed response, and then time shifting the time reversed response by a time constant so as to make it a causal signal.

16. The computer readable medium of claim 12 wherein
the first signal is formed by maximizing a ratio of target output signal power of the target to mean clutter power;
and wherein the target output signal power is detected at a receiver input and the mean clutter power is detected at a receiver input.

17. The computer readable medium of claim 16 wherein
the first signal is non-causal.

18. The computer readable medium of claim 16 wherein
the first signal is causal.

19. A computer readable medium comprising computer executable instructions which, when executed by a processor, perform the steps of:
receiving a given first signal at a data input device;
using a computer processor to form a non-periodic ON-OFF type signal which is based on the first signal by employing pulse width modulation;
and transmitting the non-periodic ON-OFF type signal out from a transmitter.

20. The computer readable medium of claim 19 wherein
the first signal is a time-reversed and time shifted version of a target impulse response waveform q(t) and the first signal is given by q(tₒ−t),
where tₒ a time constant by which a time-reversed signal q(−t), of the first signal is shifted so as to make the first signal causal.

21. The computer readable medium of claim 19 wherein
the first signal is given by an inverse Fourier transform of
$$\frac{{Q}^{*} ( ω )}{{G}_{c} ( ω )} ,$$
where Q*(ω) represents a complex conjugate of a Fourier transform of a target impulse response signal waveform q(t),
and G_{c}(ω) represents a clutter power spectral density in the frequency domain.

22. The computer readable medium of claim 19 wherein
the first signal is given by an inverse Fourier transform of L_{c}⁻¹(jω)K(ω),
wherein L_{c}⁻¹(jω) represents an inverse of a minimum phase function associated with a spectral factorization G_{c}(ω)=|L_{c}(jω)|², and G_{c}(ω) represents a clutter power spectral density in the frequency domain at the receiver input; K(ω) represents a Fourier transform of g*(tₒ−t)u(t), wherein u(t) represents a unit step function that is defined to be unity for t≧0, and zero otherwise, wherein t represents time, tₒ represents a constant time interval, and g(t) represents an inverse Fourier transform of L_{c}⁻¹(jω)Q(ω), wherein Q(ω) represents a Fourier transform of the target impulse response waveform q(t).

23. An apparatus comprising
means for forming a first signal;
means for forming a periodic ramp waveform signal with a fixed period and a fixed slope;
means for overlapping the periodic ramp waveform signal and the first signal to determine a plurality of intersection points;
means for generating a non-periodic ON-OFF signal using the plurality of intersection points; and
means for transmitting the non-periodic ON-OFF signal out from a transmitter as a transmit signal towards a target.

24. The apparatus of claim 23 wherein
the non-periodic ON-OFF signal is either at an ON level or an OFF level;
wherein the non-periodic ON-OFF signal while at the ON level is at a constant level; and
wherein the non-periodic ON-OFF signal while at the OFF level is at a zero level.

25. The apparatus of claim 24 further comprising
means for selecting the constant level so that the energy of the non-periodic ON-OFF signal is a desired level.

26. The apparatus of claim 23 wherein
the first signal is comprised of a target matched signal waveform that is obtained by time-reversing a target impulse response signal to obtain a time-reversed response, and then time shifting the time-reversed response by a time constant so as to form the first signal, so that the first signal is a causal signal.

27. The apparatus of claim 23 wherein
the first signal is formed by maximizing a ratio of target output signal power of the target to mean clutter power; and further comprising
means for detecting the target output signal power and the mean clutter power.

28. The apparatus of claim 27 wherein
the first signal is non-causal.

29. The apparatus of claim 27 wherein
the first signal is causal.

30. An apparatus comprising
means for receiving a first signal;
means for forming a non-periodic ON-OFF type signal which is based on the first signal by employing pulse width modulation; and
means for transmitting the non-periodic ON-OFF type signal out from a transmitter.

31. The apparatus of claim 30 further wherein
the first signal is a time-reversed and time shifted version of a target impulse response waveform q(t) and the first signal is given by q(tₒ−t),
where tₒ a time constant by which a time-reversed signal q(t), of the first signal is shifted so as to make the first signal causal.

32. The apparatus of claim 30 wherein
the first signal is given by an inverse Fourier transform of
$$\frac{{Q}^{*} ( ω )}{{G}_{c} ( ω )} ,$$
where Q*(ω) represents a complex conjugate of a Fourier transform of a target impulse response signal waveform q(t), and G_{c}(ω) represents a clutter power spectral density in the frequency domain.

33. The apparatus of claim 30 wherein
the first signal is given by an inverse Fourier transform of L_{c}⁻¹(jω)K(ω),
wherein L_{c}⁻¹(jω) represents an inverse of a minimum phase function associated with a spectral factorization G_{c}(ω)=|L_{c}(ω)|², and G_{c}(ω) represents a clutter power spectral density in the frequency domain at a receiver input; K(ω) represents a Fourier transform of g*(tₒ−t)u(t), wherein u(t) represents a unit step function that is defined to be unity for t≧0, and zero otherwise, wherein t represents time, tₒ represents a constant time interval, and g(t) represents an inverse Fourier transform of L_{c}⁻¹(jω)Q(ω), wherein Q(ω) represents a Fourier transform of the target impulse response waveform q(t).
